(19) United States
(12) Patent Application Publication
(10) Pub. No.: US 2024/0215123 A1
(43) Pub. Date: Jun. 27, 2024

(54) INDUCTION HEATING APPARATUS AND CONTROL METHOD OF THE SAME

(71) Applicant: Samsung Electronics Co., Ltd., Suwon-si (KR)

(72) Inventors: Hongjoo KANG, Suwon-si (KR); Eundae Bae, Suwo-si (KR); Younghoon Woo, Suwon-si (KR); Jiwoong Choi, Suwon-si (KR); Myoungjin Ham, Suwon-si (KR)

(21) Appl. No.: 18/215,084

(22) Filed: Jun. 27, 2023

Related U.S. Application Data
(63) Continuation of application No. PCT/KR2023/007525, filed on Jun. 1, 2023.

(30) Foreign Application Priority Data
Aug. 17, 2022 (KR) 10-2022-0102985
Dec. 7, 2022 (KR) 10-2022-0170086

(51) Int. Cl. H05B 6/06; H05B 6/12; H05B 6/44

(52) U.S. Cl. CPC H05B 6/065; H05B 6/1272; H05B 6/44; H05B 2213/05

(57) ABSTRACT

An induction heating apparatus includes a plate including a plurality of cooking areas, a plurality of working coils arranged below the plate to correspond to the plurality of cooking areas, respectively, a plurality of coil switches connected to the plurality of working coils, respectively, a first inverter circuit connected to one end of a first coil switch and one end of a second coil switch among the plurality of coil switches, a second inverter circuit connected to one end of a third coil switch and one end of a fourth coil switch among the plurality of coil switches, and a branch switch connected to an other end of the second coil switch and to an other end of the third coil switch.

### CROSS-REFERENCE TO RELATED APPLICATION(S)

This application claims priority to Korean Patent Application No. 10-2022-0102985, filed on Aug. 17, 2022, and Korean Patent Application No. 10-2022-0170086, filed on Dec. 7, 2022, and all the benefits accruing therefrom under 35 U.S.C. § 119, the contents of which in their entireties are herein incorporated by reference.

### BACKGROUND

### 1. Field

The disclosure relates to an induction heating apparatus for heating a vessel by induction heating and a method of controlling the same.

### 2. Description of Related Art

An induction heating apparatus is a cooking device that heats a cooking vessel using an electromagnetic induction phenomenon. The induction heating apparatus is considered beneficial in terms of stability, convenience of use and environmental protection compared to conventional gas ranges, so the induction heating apparatus is more widely used in recent years.

An induction heating apparatus typically includes a plate on which a cooking vessel is placed and a working coil provided below the plate. When an electric current is applied to the working coil to generate a magnetic field, secondary current is induced in the cooking vessel placed on the plate, and Joule heat is generated by resistance components of the cooking vessel itself. When the induction heating apparatus operates, the cooking vessel itself generates heat. A cooking vessel formed of a metal such as iron, stainless steel or nickel may be used for induction heating apparatuses.

The plate may have a plurality of cooking areas. A plurality of working coils corresponding to the plurality of cooking areas may be included in the induction heating apparatus. Each of the working coils is connected to an inverter circuit. An electric current may flow in the working coils by the operation of the inverter circuit.

### SUMMARY

The disclosure is directed to an induction heating apparatus in which inverter circuits connected to working coils are switched to correspond to the position and size of a plurality of cooking vessels disposed on a plate, and a method of controlling the induction heating apparatus.

According to an embodiment of the disclosure, there is provided an induction heating apparatus including a plate including a plurality of cooking areas, a plurality of working coils arranged below the plate to correspond to the plurality of cooking areas, respectively, a plurality of coil switches connected to the plurality of working coils, respectively, a first inverter circuit connected to one end of a first coil switch and one end of a second coil switch among the plurality of coil switches, a second inverter circuit connected to one end of a third coil switch and one end of a fourth coil switch among the plurality of coil switches, and a branch switch connected to an other end of the second coil switch and to an other end of the third coil switch.

In an embodiment, the plurality of working coils may include a first working coil connected to an other end of the first coil switch, a second working coil connected to the other end of the second coil switch, a third working coil connected to the other end of the third coil switch and a fourth working coil connected to an other end of the fourth coil switch. In such an embodiment, the second working coil and the third working coil may be disposed adjacent to each other, and the branch switch may connect or separate the second working coil and the third working coil to or from each other.

In an embodiment, one end of the branch switch may be connected to a connection node to which the second working coil and the second coil switch are connected, and an other end of the branch switch may be connected to a connection node, to which the third working coil and the third coil switch are connected.

In an embodiment, one of the second coil switch and the third coil switch may be opened and the other of the second coil switch and the third coil switch may be closed in a state in which the branch switch is closed.

In an embodiment, the induction heating apparatus may further include a controller configured to control the plurality of coil switches, the branch switch, the first inverter circuit and the second inverter circuit. In such an embodiment, the controller may be configured to close the branch switch and open one of the second coil switch and the third coil switch in response to a request to close the first coil switch or the fourth coil switch in a state in which the second coil switch and the third coil switch are closed and the branch switch is open.

In an embodiment, the induction heating apparatus may further include a vessel sensor configured to detect at least one cooking vessel placed on at least one of the plurality of cooking areas including a first cooking area, a second cooking area, a third cooking area and a fourth cooking area. In such an embodiment, the controller may be configured to identify whether a second cooking vessel is additionally detected on the first cooking area corresponding to the first working coil or the fourth cooking area corresponding to the fourth working coil, in a state in which a first cooking vessel is detected on the second cooking area corresponding to the second working coil and the third cooking area corresponding to the third working coil, and determine that the request to close the first coil switch or the fourth coil switch is made based on the second cooking vessel being detected.

In an embodiment, in response to the request to close the first coil switch or the fourth coil switch, the controller may be configured to stop operating the first inverter circuit and the second inverter circuit, and the controller may be configured to close the first coil switch or the fourth coil switch, close the branch switch, open one of the second coil switch and the third coil switch, and operate the first inverter circuit and the second inverter circuit again.

In an embodiment, the induction heating apparatus may further include an input interface configured to obtain a user input. In such an embodiment, the controller may be configured to, when operating the first inverter circuit again, determine a first output of the first inverter circuit based on the user input. In such an embodiment, the controller may be configured to, when operating the second inverter circuit again, determine a second output of the second inverter circuit as a previous output of the second inverter circuit which is set before the operation of the second inverter circuit is stopped.

In an embodiment, the controller may be configured to adjust a first output of the first inverter circuit and a second output of the second inverter circuit independently of each other based on the user input.

In an embodiment, the first inverter circuit and the second inverter circuit may be connected in parallel with each other.

According to an embodiment of the disclosure, there is provided a method of controlling an induction heating apparatus including a plurality of working coils corresponding to a plurality of cooking areas, a plurality of coil switches connected to the plurality of working coils, respectively, and a first inverter circuit and a second inverter circuit to apply an electric current to the plurality of working coils. In such an embodiment, the plurality of working coils includes a first working coil connected to the first inverter circuit via a first coil switch, a second working coil connected to the first inverter circuit via a second coil switch, a third working coil connected to the second inverter circuit via a third coil switch and a fourth working coil connected to the second inverter circuit via a fourth coil switch.

In such an embodiment, the method includes detecting, by a vessel sensor, a first cooking vessel on the second working coil and the third working coil when the first cooking vessel is placed on a second cooking area corresponding to the second working coil and a third cooking area corresponding to the third working coil, among the plurality of cooking areas, closing, by a controller, the second coil switch and the third coil switch and opening a branch switch connected to the second working coil and the third working coil based on the first cooking vessel being detected, detecting, by the vessel sensor, a second cooking vessel on the first working coil or the fourth working coil when the second cooking vessel is placed on a first cooking area corresponding to the first working coil or a fourth cooking area corresponding to the fourth working coil, among the plurality of cooking areas, closing, by the controller, the first coil switch or the fourth coil switch based on the second cooking vessel being detected, and closing the branch switch and opening one of the second coil switch and the third coil switch based on the second cooking vessel being detected.

In an embodiment, the first inverter circuit and the second inverter circuit may be controlled to stop the operation based on the second cooking vessel being detected on the first working coil or the fourth working coil, and may be controlled to operate again after the plurality of coil switches and the branch switch are open or closed.

In an embodiment, the operating of the first inverter circuit and the second inverter circuit again may include determining a first output of the first inverter circuit based on a user input obtained through an input interface, and determining a second output of the second inverter circuit as a previous output of the second inverter circuit which is set before the operation of the second inverter circuit is stopped.

In an embodiment, a first output of the first inverter circuit and a second output of the second inverter circuit may be adjusted independently of each other based on a user input obtained through an input interface.

### BRIEF DESCRIPTION OF THE DRAWINGS

FIG. 1 is a diagram showing an appearance of an induction heating apparatus according to an embodiment.

FIG. 2 shows a plurality of working coils in a body of an induction heating apparatus.

FIG. 3 is a diagram for describing the heating principle of an induction heating apparatus.

FIG. 4 is a diagram for explaining the heating principle of an induction heating apparatus.

FIG. 5 is a block diagram showing a control configuration of an induction heating apparatus according to an embodiment.

FIG. 6 is a block diagram showing components of a coil driver circuit according to an embodiment.

FIG. 7 is a block diagram showing components of a coil driver circuit according to an embodiment.

FIG. 8 is a circuit diagram of the coil driver circuit described in FIGS. 6 and 7.

FIG. 9 shows a flow of electric current in a coil driver circuit when a cooking vessel is disposed on a third cooking area and a fourth cooking area.

FIG. 10 shows a flow of electric current in a coil driver circuit when cooking vessels are disposed on a first cooking area, a third cooking area and a fourth cooking area.

FIG. 11 shows a flow of electric current in a coil driver circuit when a cooking vessel is disposed on a second cooking area and a third cooking area.

FIG. 12 shows a flow of electric current in a coil driver circuit when a cooking vessel is disposed on a second cooking area, a third cooking area and a fourth cooking area.

FIG. 13 shows a flow of electric current in a coil driver circuit when a first cooking vessel is disposed on a second cooking area and a third cooking area, and a second cooking vessel is added on a first cooking area.

FIG. 14 shows a flow of electric current in a coil driver circuit when a first cooking vessel is disposed on a second cooking area and a third cooking area, and a second cooking vessel is added on a fourth cooking area.

FIG. 15 shows a flow of electric current in a coil driver circuit when a first cooking vessel is disposed on a second cooking area, a third cooking area and a fourth cooking area, and a second cooking vessel is added on a first cooking area.

FIG. 16 shows a flow of electric current in a coil driver circuit when a first cooking vessel is disposed on a first cooking area, a second cooking area and a third cooking area, and a second cooking vessel is added on a fourth cooking area.

FIG. 17 is a flowchart showing a method of controlling an induction heating apparatus according to an embodiment.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present.

The terminology used herein is for the purpose of describing particular embodiments only and is not intended to be limiting. As used herein, “a”. “an,” “the,” and “at least one” do not denote a limitation of quantity, and are intended to include both the singular and plural, unless the context clearly indicates otherwise. For example, “an element” has the same meaning as “at least one element,” unless the context clearly indicates otherwise. “At least one” is not to be construed as limiting “a” or “an.” “Or” means “and/or.” As used herein, the term “and/or” includes any and all combinations of one or more of the associated listed items.

The terms “comprising”. “including”. “having”, and the like, when used in this disclosure, specify the stated features, numerals, steps, operations, elements, components or groups thereof, but do not preclude the presence or addition of one or more other features, numerals, steps, operations, elements, components or groups thereof.

The terms “unit”, “-er/or”, “block”, “member”, “module” used herein may refer to a processing unit of at least one function or operation. For example, the terms may refer to at least one hardware such as a field-programmable gate array (FPGA)/an application specific integrated circuit (ASIC), at least one software stored in a memory or at least one process processed by a processor.

The ordinal numbers such as “first”, “second” and the like used before elements described herein are used to distinguish the elements, and do not have any other meaning such as order of connection, use and priority between the elements.

The sign affixed to each step is used to identify each step and does not indicate the sequence between each step, and each step may be performed differently from the stated sequence unless the context clearly indicates otherwise.

In this disclosure, “at least one of . . . ” or “at least one selected from . . . ” used when describing a list of elements may change a combination of elements. For example, “at least one of a, b, or c” or “at least one selected from a, b, and c” may be understood as indicating only a, only b, only c, both a and b, both a and c, both b and c, all of a, b, and c, or any combination thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The terms “below” or “beneath” can, therefore, encompass both an orientation of above and below.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within +30%, 20%, 10% or 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Hereinafter, embodiments of the disclosure will be described in detail with reference to the accompanying drawings.

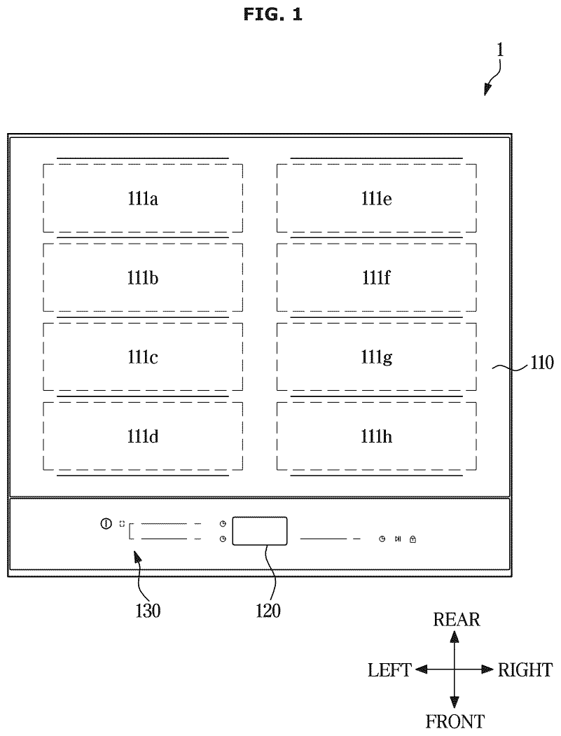

FIG. 1 is a diagram showing an appearance of an induction heating apparatus according to an embodiment.

FIG. 1 is a plan view of the induction heating apparatus 1 according to an embodiment when viewed from top. The induction heating apparatus 1 includes a plate 110 provided on an upper portion of a body, a display 120 and an input interface 130 on the body. Components of the induction heating apparatus 1 may be disposed in the body. The plate 110 may include or be formed of various materials. For example, the plate 110 may be formed of tempered glass such as ceramic glass.

The plate 110 may be provided on the upper portion of the body with a plurality of cooking areas 111a, 111b, 111c, 111d, 111e, 111f, 111g, and 111h. The plurality of cooking areas 111a, 111b, 111c, 111d, 111e, 111f, 111g, and 111h refers to a location at which a cooking vessel is placed, and may be divided by straight boundary lines to guide the proper placement of the cooking vessel. The plurality of cooking areas 111a, 111b, 111c, 111d, 111e, 111f, 111g, and 111h may be arranged in a matrix form.

For example, the plate 110 may include a first cooking area 111a, a second cooking area 111b, a third cooking area 111c, a fourth cooking area 111d, a fifth cooking area 111e, a sixth cooking area 111f, a seventh cooking area 111g and an eighth cooking area 111h. The first cooking area 111a, the second cooking area 111b, the third cooking area 111c and the fourth cooking area 111d may be aligned with each other along the front-rear direction on the left side of the plate 110. The fifth cooking area 111e, the sixth cooking area 111f, the seventh cooking area 111g and the eighth cooking area 111h may be aligned with each other along the front-rear direction on the right side of the plate 110. Although FIG. 1 shows an embodiment where eight cooking areas are defined on the plate 110, the present disclosure is not limited thereto.

The display 120 and the input interface 130 may be disposed in an area of the plate 110. For example, the display 120 and the input interface 130 may be disposed in the front area of the plate 110 at a location in which the display 120 and the input interface 130 do not overlap the plurality of cooking areas 111a, 111b, 111c, 111d, 111e, 111f, 111g, and 111h. The display 120 and the input interface 130 are not limited to the illustrated location, and their location may change or be variously modified according to the design.

The display 120 may display various pieces of information associated with the state and operation of the induction heating apparatus 1. The input interface 130 may obtain a user input about the operation of the induction heating apparatus 1. The input interface 130 may include at least one of various input devices such as a touch button, a touch pad, a physical button and a dial. The display 120 and the input interface 130 may be provided as a touch screen.

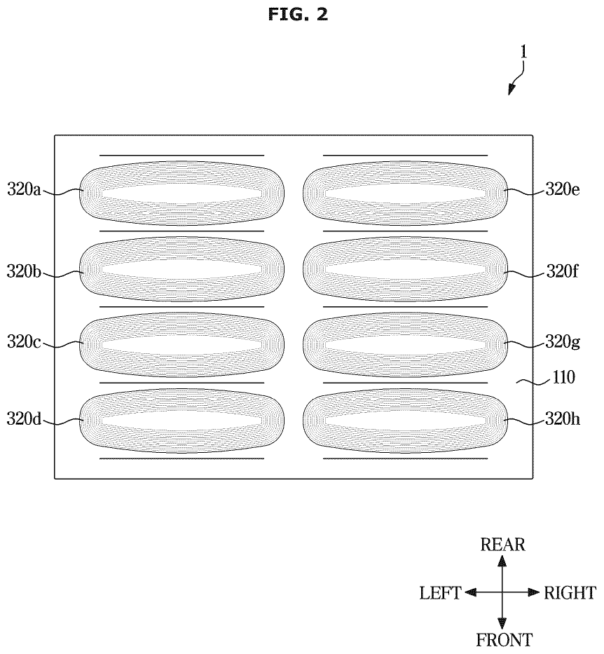

FIG. 2 shows a plurality of working coils in the body of the induction heating apparatus.

Referring to FIG. 2, a plurality of working coils 320a, 320b, 320c, 320d, 320e, 320f, 320g and 320h may be arranged below the plate 110. The plurality of working coils 320a, 320b, 320c, 320d, 320e, 320f, 320g and 320h may be disposed at corresponding locations to the plurality of cooking areas 111a, 111b, 111c, 111d, 111e, 111f, 111g, and 111h, respectively. The plurality of working coils 320a, 320b, 320c, 320d, 320e. 320f, 320g and 320h may be arranged in a matrix form. Each of the plurality of working coils 320a, 320b, 320c, 320d, 320e, 320f, 320g and 320h may have a spirally wound shape.

A first working coil 320a may be disposed below (or to overlap) the first cooking area 111a, a second working coil 320b may be disposed below the second cooking area 111b, a third working coil 320c may be disposed below the third cooking area 111c, and a fourth working coil 320d may be disposed below the fourth cooking area 111d. Additionally, a fifth working coil 320e may be disposed below the fifth cooking area 111e, a sixth working coil 320f may be disposed below the sixth cooking area 111f, a seventh working coil 320g may be disposed below the seventh cooking area 111g, and an eighth working coil 320h may be disposed below the eighth cooking area 111h.

The first working coil 320a, the second working coil 320b, the third working coil 320c and the fourth working coil 320d may be aligned with each other to form a first column along the front-rear direction of the induction heating apparatus 1. The fifth working coil 320e, the sixth working coil 320f, the seventh working coil 320g and the eighth working coil 320h may be also aligned with each other to form a second column along the front-rear direction of the induction heating apparatus 1.

Although FIG. shows an embodiment where the cooking areas and the working coils form columns along the front-rear direction of the induction heating apparatus 1, the present disclosure is not limited thereto. Alternatively, the cooking areas and the working coils may be arranged to form rows along the left-right direction.

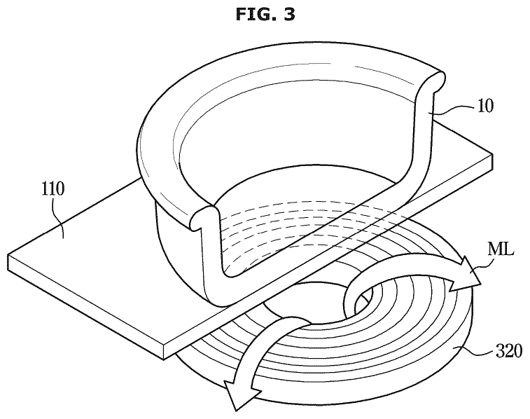

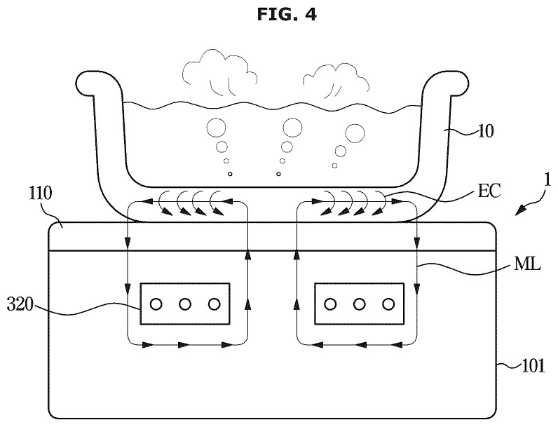

FIGS. 3 and 4 are diagrams for explaining the heating principle of the induction heating apparatus.

The working principle of each of the plurality of working coils 320a, 320b, 320c, 320d, 320e, 320f, 320g and 320h is the same as each other, the working coil 320, which will hereinafter be described in detail as an example, may correspond to any one of the plurality of working coils 320a, 320b, 320c, 320d, 320e, 320f, 320g and 320h.

Referring to FIGS. 3 and 4, the working coil 320 is positioned in the body 101 of the induction heating apparatus 1 and disposed below the plate 110. A high frequency current may be applied to the working coil 320. For example, the frequency of the high frequency current may be in a range of about 20 kHz to about 35 kHz. When the high frequency current is applied to the working coil 320, magnetic field corresponding to the magnetic field lines (ML) may be formed in the working coil 320.

When a cooking vessel 10 having (electrical) resistance is disposed within a range in which the magnetic field (ML) influence, the magnetic field lines (ML) near the working coil 320 pass through the bottom of the cooking vessel 10, and generate an induced current in the form of eddies, i.e., an eddy current (EC) according to the law of electromagnetic induction. Heat may be generated from the cooking vessel 10 by interactions between the eddy current (EC) and the electrical resistance of the cooking vessel 10, and the content in the cooking vessel 10 may be heated by the generated heat. That is, the cooking vessel 10 itself acts as a heat source. The cooking vessel 10 formed of iron, stainless steel or nickel with a resistance higher than or equal to a predetermined level may be used for the induction heating apparatus 1.

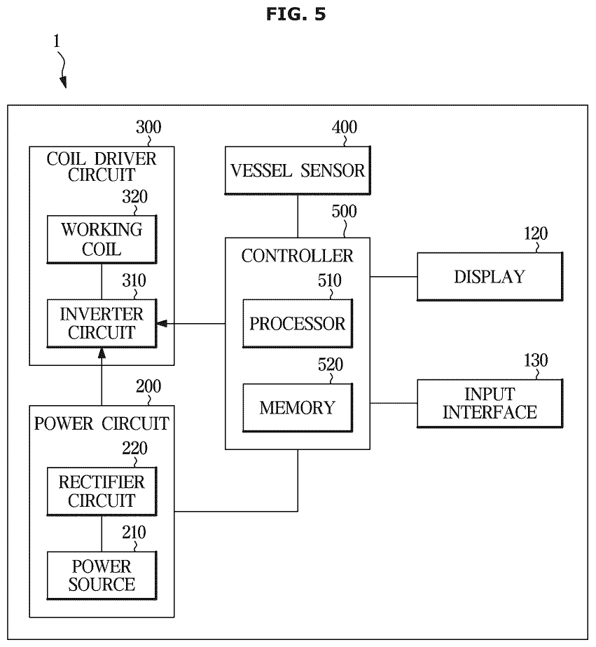

FIG. 5 is a block diagram showing the control configuration of the induction heating apparatus according to an embodiment.

Referring to FIG. 5, an embodiment of the induction heating apparatus 1 may include the display 120, the input interface 130, a power circuit 200, a coil driver circuit 300, a vessel sensor 400 and a controller 500.

The controller 500 may be electrically connected to the components of the induction heating apparatus 1, and may control the operation of each of the components. The controller 500 may include a control circuit. A printed circuit board may be provided in the body 101. The electronic components of the induction heating apparatus 1 may be installed on one printed circuit board or may be installed on a plurality of printed circuit boards in a distributed manner.

The display 120 may display information input by the user or information provided to the user as various screens. The display 120 may include a Liquid Crystal Display Panel (LCD Panel), a Light Emitting Diode Panel (LED Panel), an Organic Light Emitting Diode Panel (OLED Panel), or a micro LED panel.

The input interface 130 may obtain a user input about the operation of the induction heating apparatus 1. For example, the input interface 130 may include various buttons such as a power button, a cooking area selection button, a heating level adjustment button, a temperature setting button and/or a timer button. The input interface 130 may include at least one selected from various input devices such as a touch button, a touch pad, a physical button and a dial. The display 120 and the input interface 130 may be provided as a touch screen.

The power circuit 200 may include a power source 210. The power source 210 may supply the power used for the operation of the induction heating apparatus 1. For example, the power source 210 may be an external power source. The power circuit 200 may be connected to the coil driver circuit 300 and may supply the power to the coil driver circuit 300. Additionally, the power circuit 200 may be connected to the controller 500 and may supply the power to the controller 500.

The power circuit 200 may include a rectifier circuit 220. The rectifier circuit 220 may rectify the power supplied from the power source 210, and provide the rectified power to the coil driver circuit 300. The rectifier circuit 220 may convert alternating current (AC) power to direct current (DC) power. The rectifier circuit 220 may convert an AC voltage whose magnitude and polarity (positive voltage or negative voltage) change over time into a DC voltage whose magnitude and polarity are constant, and convert an AC current whose magnitude and direction (positive current or negative current) change over time into a DC current whose magnitude is constant.

The rectifier circuit 220 may include a bridge diode. For example, the rectifier circuit 220 may include four diodes. Every two diodes may be connected to each other in series to form a diode pair, and two diode pairs may be connected to each other in parallel. The bridge diode may convert an AC voltage whose polarity changes over time into a positive voltage whose polarity is constant, and convert an AC current whose direction changes over time into a positive current whose direction is constant.

Additionally, the rectifier circuit 220 may include a DC link capacitor. The DC link capacitor may convert positive voltage that changes the magnitude with time to DC voltage of constant magnitude. The DC link capacitor may maintain the converted DC voltage and provide it to an inverter circuit 310.

The coil driver circuit 300 may include the inverter circuit 310 and the working coil 320. The inverter circuit 310 may allow the electric current to flow in the working coil 320 by switching the voltage applied to the working coil 320. The inverter circuit 310 may include a switching circuit and a resonant capacitor to supply or interrupt the electric current to the working coil 320. The switching circuit may include at least one switch element.

One end (or a first end) of the working coil 320 may be connected to a coil switch, and the other end (or a second end opposite to the first end) of the working coil 320 may be connected to the resonant capacitor. The resonant capacitor acts as a buffer. The resonant capacitor affects the energy loss by adjusting the saturation voltage rise rate while the switch element is in an off state.

The switch element of the inverter circuit 310 may switch (or be turned) on or off in response to a control signal from the controller 500. The current and voltage may be applied to the working coil 320 by the switching operation (on-off) of the switch element. The resonant frequency of the working coil 320 may be determined by the switching speed of the switch element. Additionally, the resonant capacitor may affect the resonant frequency of the working coil 320.

Since the switch element of the inverter circuit 310 switches on or off at high speed, the switch element may be implemented in a three-terminal semiconductor device switch having fast response time. For example, the switch element may be a bipolar junction transistor (BJT), a metal-oxide-semiconductor field effect transistor (MOSFET), an insulated gate bipolar transistor (IGBT) or a thyristor.

When a heating level adjustment command for adjusting the heating level of the cooking area on which the cooking vessel is placed is obtained through the input interface 130, the controller 500 may adjust the output of the inverter circuit 310 connected to the working coil 320 of the cooking area on which the cooking vessel is placed, based on the heating level determined by the heating level adjustment command. The output of the inverter circuit 310 may refer to the magnitude of the current and/or the magnitude of the voltage applied to the working coil 320. The controller 500 may adjust the output of the inverter circuit 310 by adjusting the switching speed of the switching elements included in the inverter circuit 310. In an embodiment where a plurality of inverter circuits 310 is provided, the output of each inverter circuit 310 may be independently adjusted.

The vessel sensor 400 may detect the cooking vessel 10 disposed on the plate 110. The vessel sensor 400 may detect at least one cooking vessel placed on or to overlap at least one of the plurality of cooking areas.

The vessel sensor 400 may detect at least one of the size, position or type of the cooking vessel 10 placed on the plate 110. A plurality of vessel sensors 400 may be included. For example, the vessel sensor 400 may be disposed at the center of the working coil 320. The vessel sensor 400 may be disposed between every two working coils.

The vessel sensor 400 may include a capacitance sensor to detect a change in capacitance by the vessel 10. Additionally, the vessel sensor 400 may include at least one selected from an infrared sensor, a micro switch and a membrane switch. Furthermore, the vessel sensor 400 may include at least one selected from other various sensors.

The controller 500 may identify the presence or absence of the cooking vessel 10 on the plate 110 based on a detection signal generated by the vessel sensor 400. Additionally, the controller 500 may identify the cooking area on which the cooking vessel 10 is disposed among the plurality of cooking areas based on the detection signal transmitted from the vessel sensor 400. The controller 500 may determine at least one working coil that will be used to heat the cooking vessel 10 among the plurality of working coils based on the position and size of the cooking vessel 10.

The controller 500 may include a processor 510 and a memory 520. The memory 520 may store programs, instructions and data for controlling the operation of the induction heating apparatus 1. The processor 510 may generate the control signal for controlling the operation of the induction heating apparatus 1 based on the programs, instructions and data recorded and/or stored in the memory 520. The controller 500 may be implemented in a control circuit having the processor 510 and the memory 520 mounted thereon. Additionally, the controller 500 may include a plurality of processors and a plurality of memories.

The processor 510 may include a logic circuit and an arithmetic circuit as hardware. The processor 510 may process data according to the programs and/or instructions provided from the memory 520, and generate the control signal according to the processing result. The memory 520 may include a volatile memory for temporarily storing data such as a Static Random Access Memory (SRAM) or a Dynamic Random Access Memory (DRAM), and a nonvolatile memory for storing data for long periods of time such as a Read Only Memory (ROM), an Erasable Programmable Read Only Memory (EPROM) or an Electrically Erasable Programmable Read Only Memory (EEPROM).

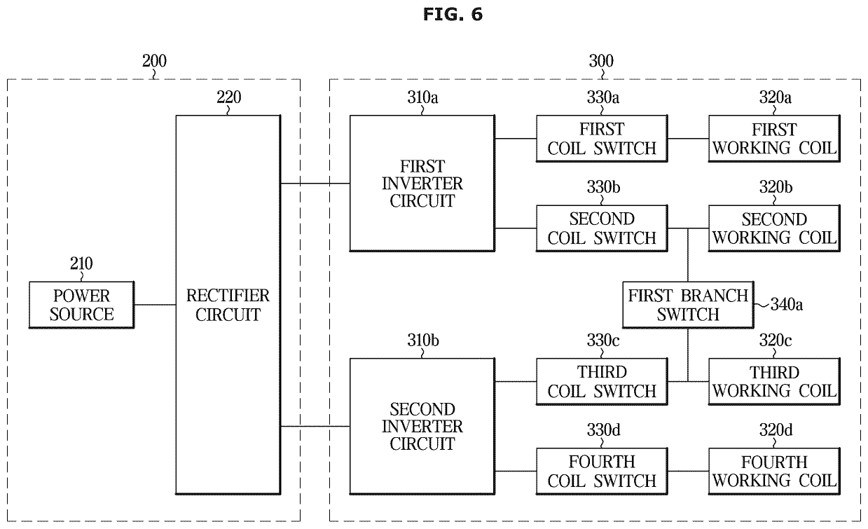

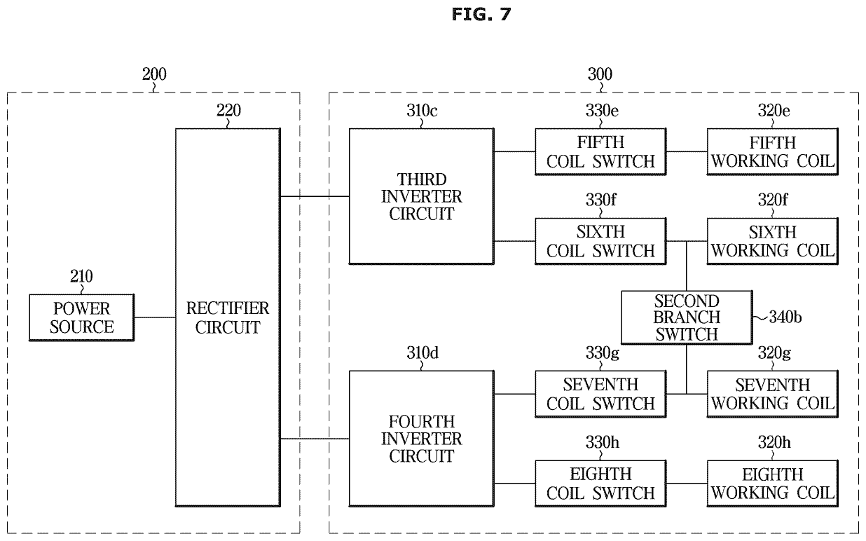

FIGS. 6 and 7 are block diagrams showing the components of the coil driver circuit according to an embodiment.

Referring to FIGS. 6 and 7, an embodiment of the coil driver circuit 300 may include a plurality of inverter circuits 310a, 310b, 310c and 310d. For example, the coil driver circuit 300 may include a first inverter circuit 310a, a second inverter circuit 310b, a third inverter circuit 310c and a fourth inverter circuit 310d. Although FIGS. 6 and 7 shows an embodiment where four inverter circuits are included in the coil driver circuit 300, the present disclosure is not limited thereto. The number of inverter circuits may change depending on the number of working coils.

Each of the first inverter circuit 310a, the second inverter circuit 310b, the third inverter circuit 310c and the fourth inverter circuit 310d may be connected to the rectifier circuit 220. The rectifier circuit 220 may apply the voltage and current to each of the plurality of inverter circuits 310a, 310b, 310c and 310d.

The coil driver circuit 300 includes the plurality of working coils 320a, 320b, 320c. 320d, 320e, 320f, 320g and 320h, and may include a plurality of coil switches 330a, 330b, 330c, 330d, 330e, 330f, 330g, and 330h respectively connected to the plurality of working coils 320a, 320b, 320c, 320d, 320e, 320f, 320g and 320h. Each of the plurality of coil switches 330a, 330b, 330c, 330d, 330e, 330f, 330g, and 330h may be connected to a corresponding one of the plurality of inverter circuits 310a, 310b, 310c and 310d.

Additionally, the coil driver circuit 300 may include branch switches 340a, 340b to connect or separate (i.e., disconnect) two adjacent working coils among the plurality of working coils 320a, 320b, 320c, 320d, 320e, 320f, 320g and 320h to or from each other.

The coil driver circuit 300 may be divided into a first coil driver circuit and a second coil driver circuit. For example, as shown in FIG. 6, the first coil driver circuit may include the first inverter circuit 310a, the second inverter circuit 310b, the first working coil 320a, the second working coil 320b, the third working coil 320c and the fourth working coil 320d. As shown in FIG. 7, the second coil driver circuit may include the third inverter circuit 310c, the fourth inverter circuit 310d, the fifth working coil 320e, the sixth working coil 320f, the seventh working coil 320g and the eighth working coil 320h.

The structure of the first coil driver circuit and the structure of the second coil driver circuit are the same as each other. In an embodiment in which the induction heating apparatus 1 includes only four working coils, the coil driver circuit 300 may be provided as the first coil driver circuit or the second coil driver circuit.

Referring to FIG. 6, the first inverter circuit 310a may be connected to each of a first coil switch 330a and a second coil switch 330b. The first coil switch 330a may be connected to the first working coil 320a, and the second coil switch 330b may be connected to the second working coil 320b. The second inverter circuit 310b may be connected to each of a third coil switch 330c and a fourth coil switch 330d. The third coil switch 330c may be connected to the third working coil 320c, and the fourth coil switch 330d may be connected to the fourth working coil 320d.

A first branch switch 340a may connect or separate the second working coil 320b and the third working coil 320c to or from each other. The first branch switch 340a may be connected between a connection node of the second coil switch 330b and the second working coil 320b and a connection node of the third coil switch 330c and the third working coil 320c.

Referring to FIG. 7, the third inverter circuit 310c may be connected to each of a fifth coil switch 330e and a sixth coil switch 330f. The fifth coil switch 330e may be connected to the fifth working coil 320e, and the sixth coil switch 330f may be connected to the sixth working coil 320f. The fourth inverter circuit 310d may be connected to each of a seventh coil switch 330g and an eighth coil switch 330h. The seventh coil switch 330g may be connected to the seventh working coil 320g, and the eighth coil switch 330h may be connected to the eighth working coil 320h.

A second branch switch 340b may connect or separate the sixth working coil 320f and the seventh working coil 320g to or from each other. The second branch switch 340b may be connected between a connection node of the sixth coil switch 330f and the sixth working coil 320f and a connection node of the seventh coil switch 330g and the seventh working coil 320g.

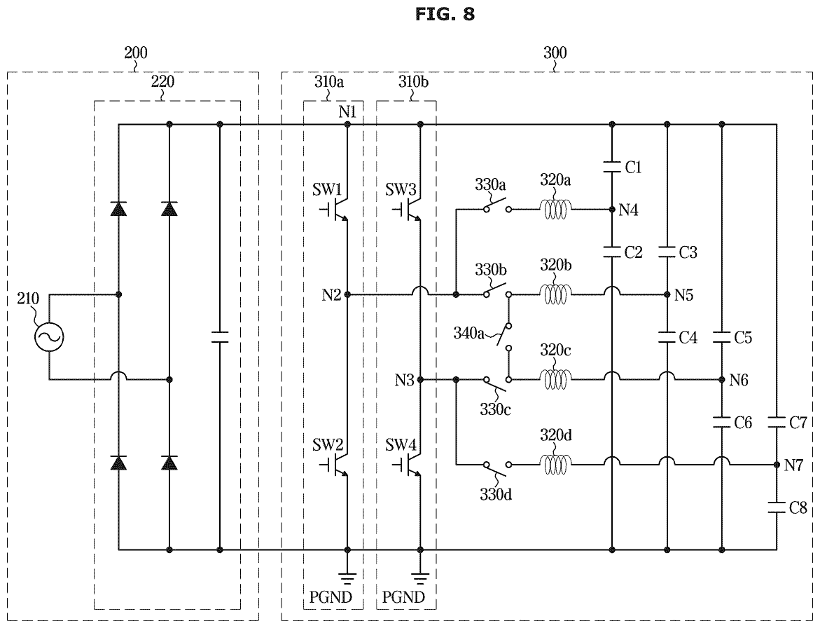

FIG. 8 is a circuit diagram of the coil driver circuit described in FIGS. 6 and 7.

As described above, an embodiment of the coil driver circuit 300 may include at least one of the coil driver circuit of FIG. 6 or the coil driver circuit of FIG. 7 according to the design. Hereinafter, the circuit structure of the coil driver circuit of FIG. 6 will be described in detail. The circuit structure of the coil driver circuit of FIG. 6 and the circuit structure of the coil driver circuit of FIG. 7 are the same as each other, and to avoid redundancy, the detailed circuit of FIG. 7 is omitted.

Referring to FIG. 8, the power circuit 200 may include the power source 210 and the rectifier circuit 220. The coil driver circuit 300 is connected to a first node N1 of the rectifier circuit 220 and a ground node PGND of the rectifier circuit 220. Each of the first inverter circuit 310a and the second inverter circuit 310b is connected to the rectifier circuit 220. The first inverter circuit 310a and the second inverter circuit 310b form a parallel circuit.

The first inverter circuit 310a includes a first switch element SW1 and a second switch element SW2. The first switch element SW1 and the second switch element SW2 are connected to each other in series. One end of the first coil switch 330a and one end of the second coil switch 330b are connected to the first inverter circuit 310a. The one end of the first coil switch 330a and the one end of the second coil switch 330b are connected to a second node N2 between the first switch element SW1 and the second switch element SW2 of the first inverter circuit 310a.

The second inverter circuit 310b includes a third switch element SW3 and a fourth switch element SW4. The third switch element SW3 and the fourth switch element SW4 are connected to each other in series. One end of the third coil switch 330c and one end of the fourth coil switch 330d are connected to the second inverter circuit 310b. The one end of the third coil switch 330c and the one end of the fourth coil switch 330d are connected to a third node N3 between the third switch element SW3 and the fourth switch element SW4 of the second inverter circuit 310b.

The other end of the first coil switch 330a is connected to one end of the first working coil 320a. The other end of the second coil switch 330b is connected to one end of the second working coil 320b. The other end of the third coil switch 330c is connected to one end of the third working coil 320c. The other end of the fourth coil switch 330d is connected to one end of the fourth working coil 320d.

The other end of the first working coil 320a is connected to a fourth node N4 between a first resonant capacitor C1 and a second resonant capacitor C2. The first resonant capacitor C1 and the second resonant capacitor C2 are connected to each other in series. One end of the first resonant capacitor C1 is connected to the first node N1, and the other end of the first resonant capacitor C1 is connected to the fourth node N4. One end of the second resonant capacitor C2 is connected to the fourth node N4, and the other end of the second resonant capacitor C2 is connected to the ground node PGND.

The other end of the second working coil 320b is connected to a fifth node N5 between a third resonant capacitor C3 and a fourth resonant capacitor C4. The third resonant capacitor C3 and the fourth resonant capacitor C4 are connected to each other in series. One end of the third resonant capacitor C3 is connected to the first node N1, and the other end the third resonant capacitor C3 is connected to the fifth node N5. One end of the fourth resonant capacitor C4 is connected to the fifth node N5, and the other end of the fourth resonant capacitor C4 is connected to the ground node PGND.

The other end of the third working coil 320c is connected to a sixth node N6 between a fifth resonant capacitor C5 and a sixth resonant capacitor C6. The fifth resonant capacitor C5 and the sixth resonant capacitor C6 are connected to each other in series. One end of the fifth resonant capacitor C5 is connected to the first node N1, and the other end of the fifth resonant capacitor C5 is connected to the sixth node N6. One end of the sixth resonant capacitor C6 is connected to the sixth node N6, and the other end of the sixth resonant capacitor C6 is connected to the ground node PGND.

The other end of the fourth working coil 320d is connected to a seventh node N7 between a seventh resonant capacitor C7 and an eighth resonant capacitor C8. The seventh resonant capacitor C7 and the eighth resonant capacitor C8 are connected to each other in series. One end of the seventh resonant capacitor C7 is connected to the first node N1, and the other end of the seventh resonant capacitor C7 is connected to the seventh node N7. One end of the eighth resonant capacitor C8 is connected to the seventh node N7, and the other end the eighth resonant capacitor C8 is connected to the ground node PGND.

Additionally, the first branch switch 340a is connected to the other end of the second coil switch 330b and the other end of the third coil switch 330c. One end of the first branch switch 340a is connected to the one end of the second working coil 320b, and the other end of the first branch switch 340a is connected to the one end of the third working coil 320c. The first branch switch 340a may be connected between the connection node of the second coil switch 330b and the second working coil 320b and the connection node of the third coil switch 330c and the third working coil 320c.

In such an embodiment, one end of the first branch switch 340a branches off from a connection line of the second working coil 320b and the second coil switch 330b, that is, the one end of the first branch switch 340a is connected to a connection node to which the second working coil 320b and the second coil switch 330b are connected. The other end of the first branch switch 340a branches off from a connection line of the third working coil 320c and the third coil switch 330c, that is, the other end of the first branch switch 340a is connected to a connection node to which the third working coil 320c and the third coil switch 330c are connected. The first branch switch 340a may connect or separate the second working coil 320b and the third working coil 320c, which are disposed adjacent to each other, to or from each other under the control of the controller 500.

When the first branch switch 340a is closed (or turned on), the second working coil 320b and the third working coil 320c are electrically connected to each other. When both the first inverter circuit 310a and the second inverter circuit 310b are electrically connected to the second working coil 320b and the third working coil 320c, the circuit may be damaged. Accordingly, when the first branch switch 340a is closed, one of the second coil switch 330b and the third coil switch 330c is open (or turned off) and the other is closed.

As described above, the controller 500 of the induction heating apparatus 1 may determine at least one working coil to be used to heat the cooking vessel among the plurality of working coils based on the position and size of the cooking vessel.

For example, the controller 500 may identify the first cooking vessel 10 disposed on the second cooking area 111b and the third cooking area 111c of the plate 110 based on the detection signal of the vessel sensor 400. In this case, the controller 500 may close the second coil switch 330b and the third coil switch 330c, and operate the first inverter circuit 310a and the second inverter circuit 310b. The output of the first inverter circuit 310a and the output of the second inverter circuit 310b may be equally set. The first inverter circuit 310a may supply the electric current to the second working coil 320b, and the second inverter circuit 310b may supply the electric current to the third working coil 320c. Accordingly, the cooking vessel may be heated by the second working coil 320b and the third working coil 320c.

While the first cooking vessel 10 disposed on the second cooking area 111b and the third cooking area 111c of the plate 110 is being heated, a second cooking vessel 20 may be added (or additionally placed) on the first cooking area 111a. In this case, the first working coil 320a may be independently used by connecting the second working coil 320b to the second inverter circuit 310b through the first branch switch 340a. That is, the first working coil 320a and the second working coil 320b may be connected to different inverter circuits. The controller 500 may independently adjust the output of the first inverter circuit 310a connected to the first working coil 320a. The first cooking vessel 10 and the second cooking vessel 20 may be independently heated.

Likewise, while the first cooking vessel 10 disposed on the second cooking area 111b and the third cooking area 111c of the plate 110 is being heated, the second cooking vessel 20 may be added on the fourth cooking area 111d. In this case, the fourth working coil 320d may be independently used by connecting the third working coil 320c to the first inverter circuit 310a through the first branch switch 340a. That is, the third working coil 320c and the fourth working coil 320d may be connected to different inverter circuits. The controller 500 may independently adjust the output of the second inverter circuit 310b connected to the fourth working coil 320d. The first cooking vessel 10 and the second cooking vessel 20 may be independently heated.

In contrast, a conventional induction heating apparatus does not include the branch switch connected between the second working coil 320b and the third working coil 320c. Accordingly, the conventional induction heating apparatus cannot switch the inverter circuits that supply the electric current to the second working coil 320b and the third working coil 320c. In other words, in case in which the second cooking vessel 20 is added on the first cooking area 111a or the fourth cooking area 111d while the first cooking vessel 10 disposed on the second cooking area 111b and the third cooking area 111c is being heated, the existing induction heating apparatus cannot independently heat the second cooking vessel 20.

The induction heating apparatus 1 may switch the inverter circuits connected to the working coils based on the position and size of the plurality of cooking vessels disposed on the plate 110. In other words, the induction heating apparatus 1 may selectively connect some of the plurality of working coils and some others to different inverter circuits it is possible to resolve the issue of a conventional induction heating apparatus in which, depending on the arrangement of a cooking vessel on a cooking area, another cooking vessel may not be allowed to be independently heated. Accordingly, the usability of the plurality of cooking areas may be improved.

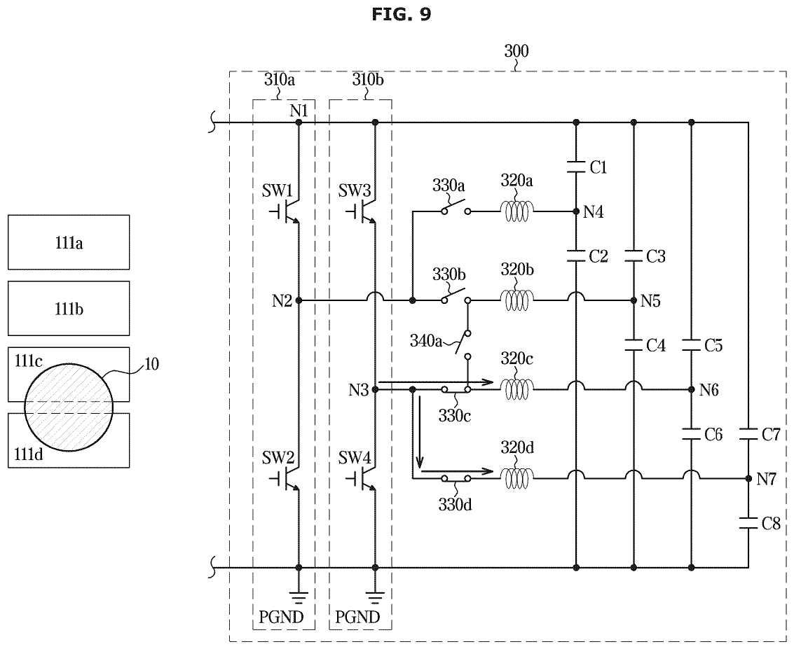

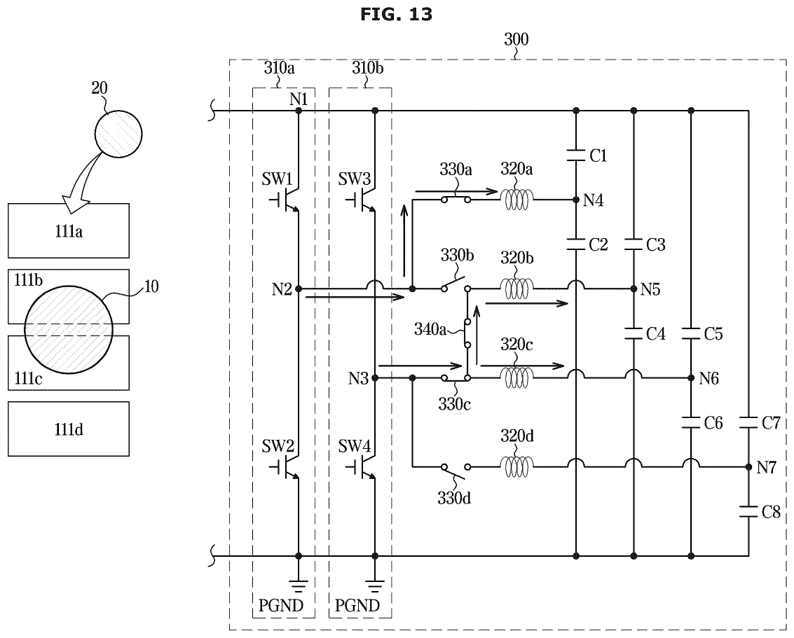

Hereinafter, various operations of the coil driver circuit 300 based on the position and size of the cooking vessel will be described. In FIGS. 9 to 16, the flow of electric current in the coil driver circuit is indicated by the arrow. The method of changing the inverter circuits connected to the working coils will be described in detail with reference to FIG. 13 and the subsequent drawings.

FIG. 9 shows the flow of electric current in the coil driver circuit when the cooking vessel is disposed on the third cooking area and the fourth cooking area.

Referring to FIG. 9, the controller 500 may identify the first cooking vessel 10 disposed on the third cooking area 111c and the fourth cooking area 111d of the plate 110. In this case, the controller 500 may close the third coil switch 330c and the fourth coil switch 330d, and operate the second inverter circuit 310b. The controller 500 may open the first coil switch 330a, the second coil switch 330b and the first branch switch 340a. By the operation of the second inverter circuit 310b, the electric current may flow in the third working coil 320c and the fourth working coil 320d. The first cooking vessel 10 may be heated by the third working coil 320c and the fourth working coil 320d.

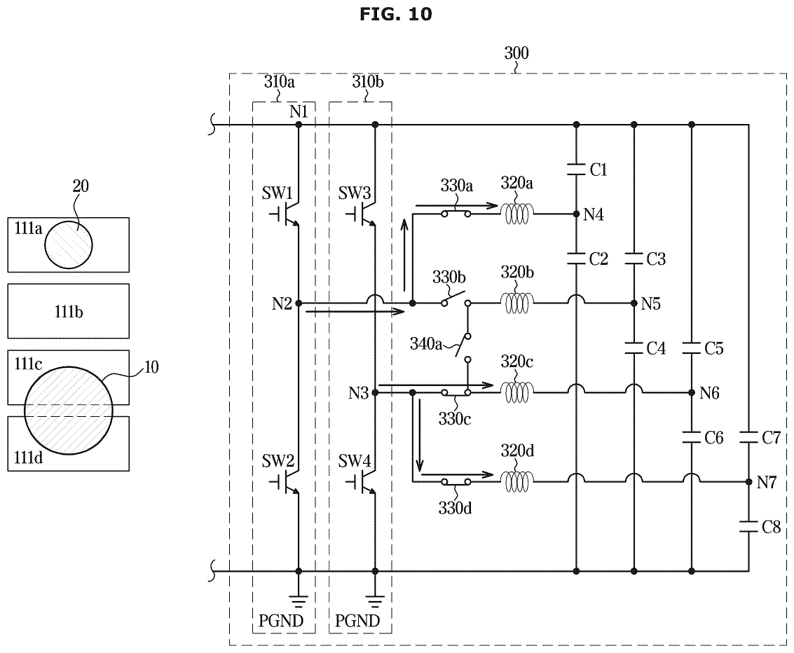

FIG. 10 shows the flow of electric current in the coil driver circuit when the cooking vessels are disposed on the first cooking area, the third cooking area and the fourth cooking area.

Referring to FIG. 10, the controller 500 may identify the first cooking vessel 10 disposed on the third cooking area 111c and the fourth cooking area 111d of the plate 110, and the second cooking vessel 20 disposed on the first cooking area 111a. In this case, the controller 500 may close the first coil switch 330a, the third coil switch 330c and the fourth coil switch 330d, and operate the first inverter circuit 310a and the second inverter circuit 310b. The controller 500 may open the second coil switch 330b and the first branch switch 340a.

By the operation of the second inverter circuit 310b, the electric current may flow in the third working coil 320c and the fourth working coil 320d. The first cooking vessel 10 may be heated by the third working coil 320c and the fourth working coil 320d. Additionally, by the operation of the first inverter circuit 310a, the electric current may flow in the first working coil 320a. The second cooking vessel 20 may be heated by the first working coil 320a.

The output of the first inverter circuit 310a and the output of the second inverter circuit 310b may be set independently of each other according to the user input. That is, the heating level of the first cooking vessel 10 and the heating level of the second cooking vessel 20 may be equally or differently set according to the user input obtained through the input interface 130.

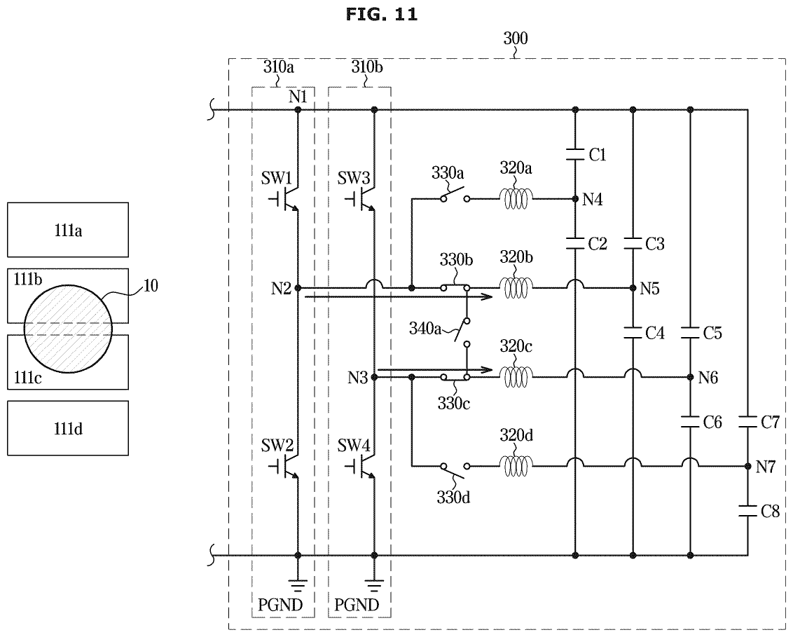

FIG. 11 shows the flow of electric current in the coil driver circuit when the cooking vessel is disposed on the second cooking area and the third cooking area.

Referring to FIG. 11, the controller 500 may identify the first cooking vessel 10 disposed on the second cooking area 111b and the third cooking area 111c of the plate 110. In this case, the controller 500 may close the second coil switch 330b and the third coil switch 330c, and operate the first inverter circuit 310a and the second inverter circuit 310b. The controller 500 may open the first coil switch 330a, the fourth coil switch 330d and the first branch switch 340a.

The first inverter circuit 310a may supply the electric current to the second working coil 320b, and the second inverter circuit 310b may supply the electric current to the third working coil 320c. The output of the first inverter circuit 310a and the output of the second inverter circuit 310b may be equally adjusted (i.e., adjusted to be equal to each other). The first cooking vessel 10 may be heated by the second working coil 320b and the third working coil 320c.

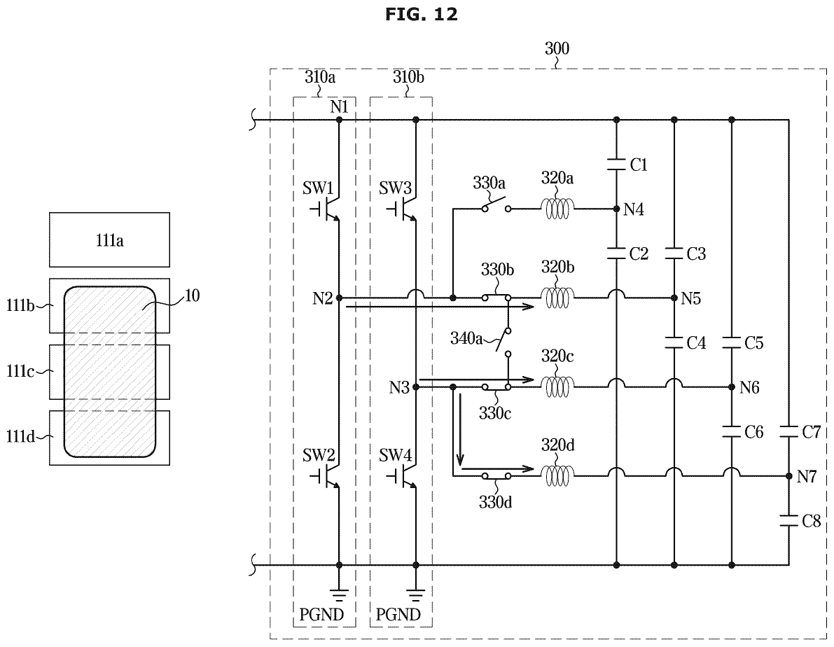

FIG. 12 shows the flow of electric current in the coil driver circuit when the cooking vessel is disposed on the second cooking area, the third cooking area and the fourth cooking area.

Referring to FIG. 12, the controller 500 may identify the first cooking vessel 10 disposed on the second cooking area 111b, the third cooking area 111c and the fourth cooking area 111d of the plate 110. In this case, the controller 500 may close the second coil switch 330b, the third coil switch 330c and the fourth coil switch 330d, and operate the first inverter circuit 310a and the second inverter circuit 310b. The controller 500 may open the first coil switch 330a and the first branch switch 340a.

The first inverter circuit 310a may supply the electric current to the second working coil 320b. The second inverter circuit 310b may supply the electric current to the third working coil 320c and the fourth working coil 320d. The output of the first inverter circuit 310a and the output of the second inverter circuit 310b may be equally adjusted. The first cooking vessel 10 may be heated by the second working coil 320b, the third working coil 320c and the fourth working coil 320d.

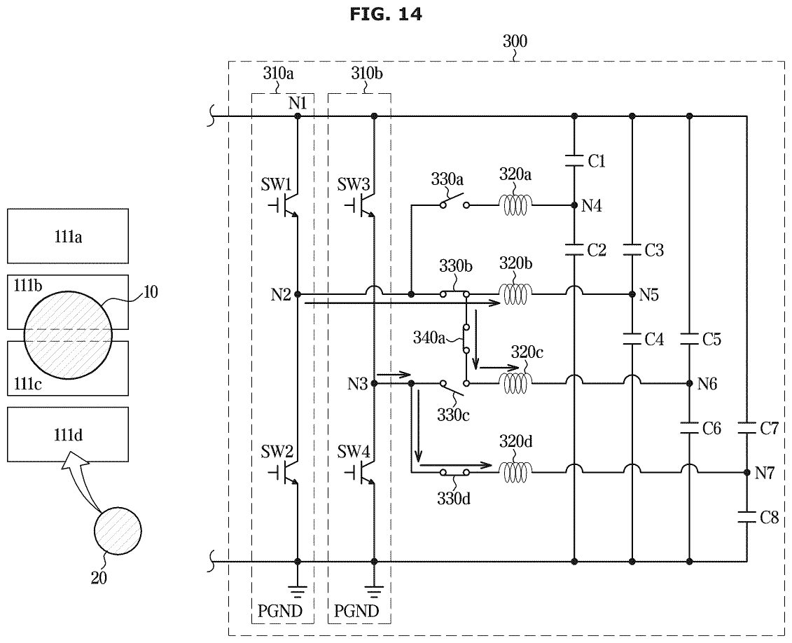

FIG. 13 shows the flow of electric current in the coil driver circuit when the first cooking vessel is disposed on the second cooking area and the third cooking area, and the second cooking vessel is added on the first cooking area. FIG. 14 shows the flow of electric current in the coil driver circuit when the first cooking vessel is disposed on the second cooking area and the third cooking area, and the second cooking vessel is added on the fourth cooking area.

Referring to FIGS. 13 and 14, the controller 500 of the induction heating apparatus 1 may identify the second cooking vessel 20 additionally detected on the first cooking area 111a corresponding to the first working coil 320a or the fourth cooking area 111d corresponding to the fourth working coil 320d, in such a state where the first cooking vessel 10 is detected on the second cooking area 111b corresponding to the second working coil 320b and the third cooking area 111c corresponding to the third working coil 320c. The controller 500 may determine that a request is made to close the first coil switch 330a or the fourth coil switch 330d based on the second cooking vessel 20 being detected.

In such a state where the second coil switch 330b and the third coil switch 330c are closed and the first branch switch 340a is open, in response to the request to close the first coil switch 330a or the fourth coil switch 330d, the controller 500 may close the first branch switch 340a, and open one of the second coil switch 330b and the third coil switch 330c.

In response to the request to close the first coil switch 330a or the fourth coil switch 330d, the controller 500 may stop the operation of the first inverter circuit 310a and the operation of the second inverter circuit 310b. Subsequently, the controller 500 may close the first coil switch 330a or the fourth coil switch 330d, close the first branch switch 340a, and open one of the second coil switch 330b and the third coil switch 330c. Subsequently, the controller 500 may operate the first inverter circuit 310a and the second inverter circuit 310b again.

When the controller 500 operates the first inverter circuit 310a again, the controller 500 may determine the first output of the first inverter circuit 310a based on the user input obtained through the input interface 130. When the controller 500 operates the second inverter circuit 310b again, the controller 500 may determine the second output of the second inverter circuit 310b as the previous output of the second inverter circuit 310b used before the operation of the second inverter circuit 310b is stopped.

That is, the user may independently set the heating level of the second cooking vessel 20 added on the first cooking area 111a or the fourth cooking area 111d by manipulation of the input interface 130. The heating level of the first cooking vessel 10 disposed on the second cooking area 111b and the third cooking area 111c may be maintained at the heating level set before the second cooking vessel 20 is added. Accordingly, the first cooking vessel 10 and the second cooking vessel 20 may be independently heated.

As shown in FIG. 11, to heat the first cooking vessel 10 disposed on the second cooking area 111b and the third cooking area 111c, the controller 500 closes the second coil switch 330b and the third coil switch 330c and opens the first coil switch 330a, the fourth coil switch 330d and the first branch switch 340a, and the controller 500 operates the first inverter circuit 310a and the second inverter circuit 310b.

In this instance, as shown in FIG. 13, when the second cooking vessel 20 is added on the first cooking area 111a, the controller 500 temporarily stops the operation of the first inverter circuit 310a and the operation of the second inverter circuit 310b. Subsequently, the controller 500 closes the first coil switch 330a, closes the first branch switch 340a, and opens the second coil switch 330b. Subsequently, the controller 500 operates the first inverter circuit 310a and the second inverter circuit 310b again. Accordingly, the first inverter circuit 310a applies the electric current to the first working coil 320a, and the second inverter circuit 310b applies the electric current to the second working coil 320b and the third working coil 320c.

FIG. 14 shows a case where the second cooking vessel 20 is added on the fourth cooking area 111d. In this case, the controller 500 temporarily stops the operation of the first inverter circuit 310a and the operation of the second inverter circuit 310b based on the second cooking vessel 20 being additionally detected on the fourth cooking area 111d. Subsequently, the controller 500 closes the fourth coil switch 330d, closes the first branch switch 340a, and opens the third coil switch 330c. Subsequently, the controller 500 operates the first inverter circuit 310a and the second inverter circuit 310b again. Accordingly, the first inverter circuit 310a applies the electric current to the second working coil 320b and the third working coil 320c, and the second inverter circuit 310b applies the electric current to the fourth working coil 320d.

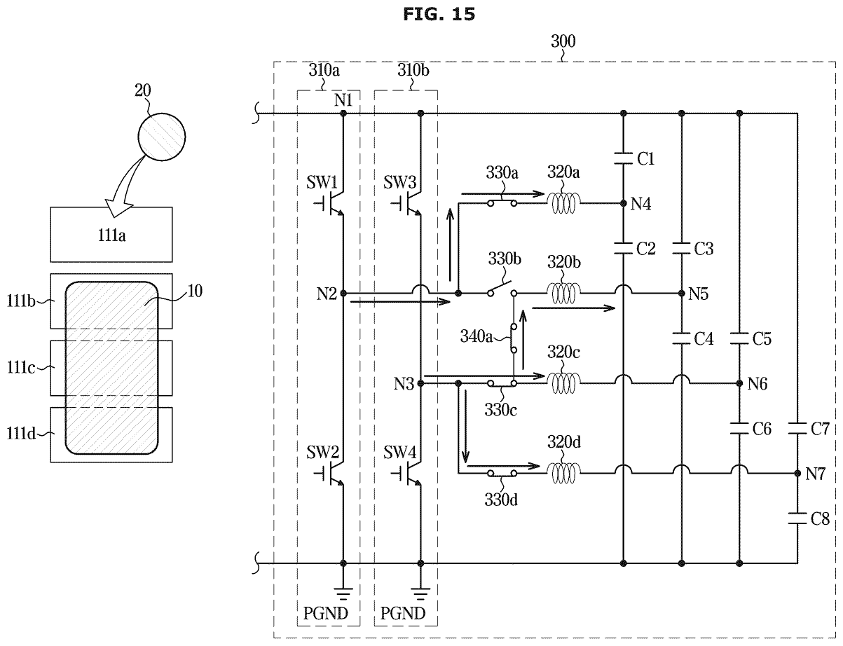

FIG. 15 shows the flow of electric current in the coil driver circuit when the first cooking vessel is disposed on the second cooking area, the third cooking area and the fourth cooking area, and the second cooking vessel is added on the first cooking area.

As described in FIG. 12, to heat the first cooking vessel 10 disposed on the second cooking area 111b, the third cooking area 111c and the fourth cooking area 111d of the plate 110, the controller 500 closes the second coil switch 330b, the third coil switch 330c and the fourth coil switch 330d, and opens the first coil switch 330a and the first branch switch 340a.

In this instance, as shown in FIG. 15, when the second cooking vessel 20 is added on the first cooking area 111a, the controller 500 temporarily stops the operation of the first inverter circuit 310a and the operation of the second inverter circuit 310b. Subsequently, the controller 500 closes the first coil switch 330a, closes the first branch switch 340a, and opens the second coil switch 330b. Subsequently, the controller 500 operates the first inverter circuit 310a and the second inverter circuit 310b again. Accordingly, the first inverter circuit 310a applies the electric current to the first working coil 320a, and the second inverter circuit 310b applies the electric current to the second working coil 320b, the third working coil 320c and the fourth working coil 320d.

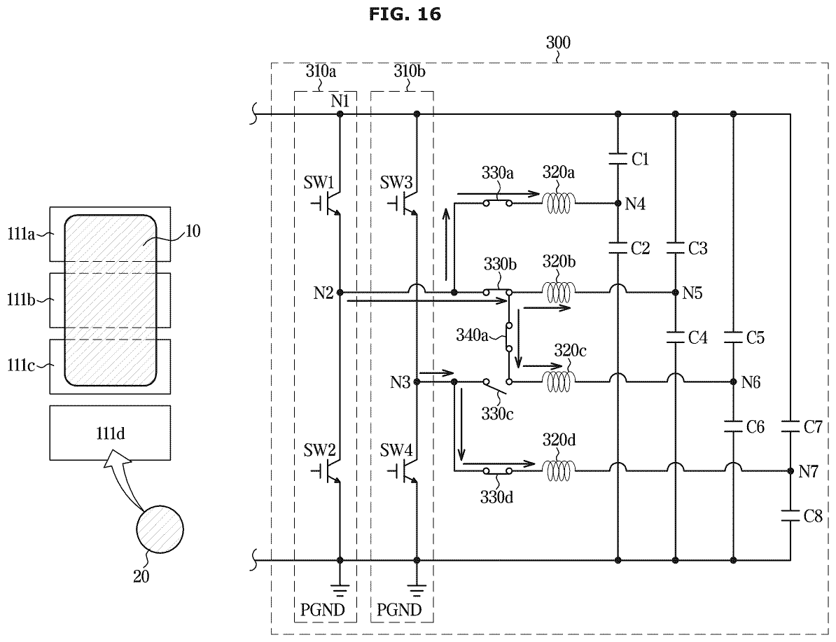

FIG. 16 shows the flow of electric current in the coil driver circuit when the first cooking vessel is disposed on the first cooking area, the second cooking area and the third cooking area, and the second cooking vessel is added on the fourth cooking area.

Referring to FIG. 16, to heat the first cooking vessel 10 disposed on the first cooking area 111a, the second cooking area 111b and the third cooking area 111c of the plate 110, the controller 500 closes the first coil switch 330a, the second coil switch 330b and the third coil switch 330c, and opens the first branch switch 340a and the fourth coil switch 330d. Additionally, the controller 500 operates the first inverter circuit 310a and the second inverter circuit 310b.

When the second cooking vessel 20 is added on the fourth cooking area 111d, the controller 500 temporarily stops the operation of the first inverter circuit 310a and the operation of the second inverter circuit 310b. Subsequently, the controller 500 closes the fourth coil switch 330d, closes the first branch switch 340a, and opens the third coil switch 330c. Subsequently, the controller 500 operates the first inverter circuit 310a and the second inverter circuit 310b again. Accordingly, the first inverter circuit 310a applies the electric current to the first working coil 320a, the second working coil 320b and the third working coil 320c, and the second inverter circuit 310b applies the electric current to the fourth working coil 320d.

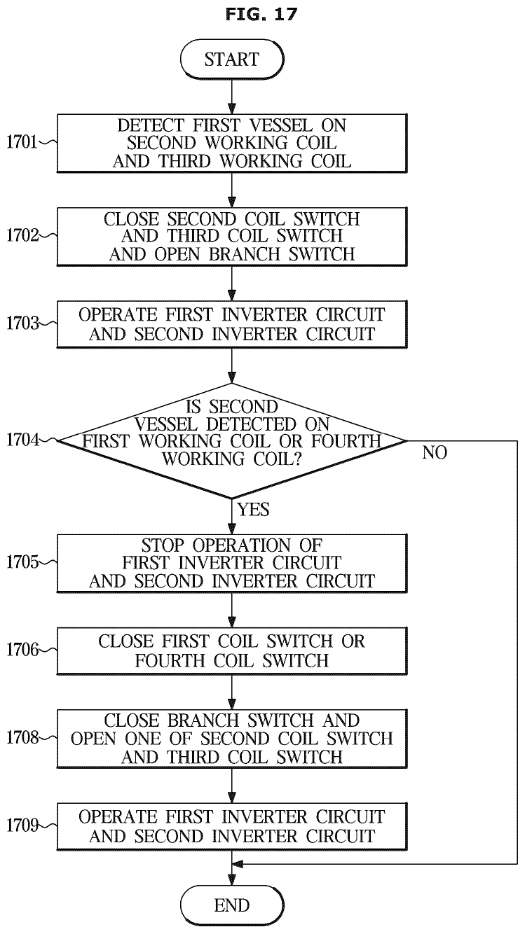

FIG. 17 is a flowchart showing a method of controlling an induction heating apparatus according to an embodiment.

Referring to FIG. 17, in an embodiment of a method of controlling an induction heating apparatus, the controller 500 of the induction heating apparatus 1 may detect the first cooking vessel 10 disposed on the second cooking area 111b and the third cooking area 111c of the plate 110 based on the detection signal of the vessel sensor 400 (1701).

In response to the first cooking vessel 10 being detected, the controller 500 may close the second coil switch 330b and the third coil switch 330c, and open the first branch switch 340a (1702). Additionally, the controller 500 may open the first coil switch 330a and the fourth coil switch 330d. The controller 500 may operate the first inverter circuit 310a and the second inverter circuit 310b (1703).

The controller 500 may determine whether the second cooking vessel 20 is additionally detected on the first cooking area 111a corresponding to the first working coil 320a or the fourth cooking area 111d corresponding to the fourth working coil 320d (1704).

The controller 500 may temporarily stop the operation of the first inverter circuit 310a and the operation of the second inverter circuit 310b based on determining that the second cooking vessel 20 is additionally detected on the first cooking area 111a corresponding to the first working coil 320a or the fourth cooking area 111d corresponding to the fourth working coil 320d (1705).

The controller 500 may close the first coil switch 330a or the fourth coil switch 330d (1706), close the first branch switch 340a, and open one of the second coil switch 330b and the third coil switch 330c (1708). Subsequently, the controller 500 may operate the first inverter circuit 310a and the second inverter circuit 310b again (1709).

The induction heating apparatus 1 and the method of controlling the induction heating apparatus 1 according to embodiments may switch the inverter circuits connected to the working coils based on the position and size of the plurality of cooking vessels disposed on the plate.

In such embodiments, the induction heating apparatus 1 and the method of controlling the induction heating apparatus 1 may selectively connect some of the plurality of working coils and some others to different inverter circuits.

In such embodiments, it is possible to resolve the issue of a conventional induction heating apparatus in which, depending on the arrangement of a cooking vessel on a cooking area, another cooking vessel may not be allowed to be independently heated. Accordingly, the usability of the plurality of cooking areas may be improved.

The embodiments of the method of controlling an induction heating apparatus described herein may be realized in the form of a storage medium for storing instructions that can be executed by a computer. The instructions may be stored in the format of program code, and may perform the disclosed embodiments by generating a program module when executed by the processor.

The machine-readable storage medium may be provided in the form of non-transitory storage medium. Here, the ‘non-transitory storage medium’ is a tangible device, and refers to excluding a signal (for example, an electromagnetic wave), and this term does not distinguish between semi-permanent data storage medium and temporary data storage medium. For example, the ‘non-transitory storage medium’ may include a buffer that temporarily stores data.

The methods according to various embodiments disclosed herein may be incorporated into a computer program product. The computer program product may be traded between a seller and a buyer as a product. The computer program product may be distributed in the form of the machine-readable storage medium (for example, compact disc read only memory (CD-ROM)), or may be distributed through an application store (for example, Play Store™) or directly between two user devices (for example, smart phones), or may be distributed online (for example, downloaded or uploaded). In the case of online distribution, at least part of the computer program product (for example, a downloadable app) may be at least temporarily stored in the machine-readable storage medium such as memory of the manufacturer's server, the application store's server or a relay server, or may be temporarily generated.

According to embodiments of the induction heating apparatus and the method of controlling the induction heating apparatus, the inverter circuits connected to the working coils can be switched based on the position and size of the plurality of cooking vessels disposed on the plate.

In such embodiments of the induction heating apparatus and the method of controlling the induction heating apparatus, some of the plurality of working coils and some others of the plurality of working coils can be selectively connected to different inverter circuits, such that it is possible to resolve the issues of a conventional induction heating apparatus in which, depending on the arrangement of a cooking vessel on a cooking area, another cooking vessel may not be allowed to be independently heated. Accordingly, the usability of the plurality of cooking areas may be improved.

The disclosed embodiments have been hereinabove described with reference to the accompanying drawings. Those having ordinary skill in the technical field pertaining to the present disclosure will understand that the present disclosure may be embodied in any other forms without changing the technical spirit or essential feature of the present disclosure. The disclosed embodiments are provided by way of illustration and should not be construed as limited.

What is claimed is:

1. An induction heating apparatus comprising:
a plate including a plurality of cooking areas;
a plurality of working coils arranged below the plate to correspond to the plurality of cooking areas, respectively;
a plurality of coil switches connected to the plurality of working coils, respectively;
a first inverter circuit connected to one end of a first coil switch and one end of a second coil switch among the plurality of coil switches;
a second inverter circuit connected to one end of a third coil switch and one end of a fourth coil switch among the plurality of coil switches; and
a branch switch connected to an other end of the second coil switch and to an other end of the third coil switch.

2. The induction heating apparatus of claim 1, wherein the plurality of working coils includes a first working coil connected to an other end of the first coil switch, a second working coil connected to the other end of the second coil switch, a third working coil connected to the other end of the third coil switch and a fourth working coil connected to an other end of the fourth coil switch,
wherein the second working coil and the third working coil are disposed adjacent to each other, and
wherein the branch switch connects or separates the second working coil and the third working coil to or from each other.

3. The induction heating apparatus of claim 2, wherein one end of the branch switch is connected to a connection node to which the second working coil and the second coil switch are connected to, and
an other end of the branch switch is connected to a connection node, to which the third working coil and the third coil switch are connected.

4. The induction heating apparatus of claim 2, wherein one of the second coil switch and the third coil switch is opened and the other of the second coil switch and the third coil switch is closed in a state in which the branch switch is closed.

5. The induction heating apparatus of claim 2, further comprising:
a controller configured to control the plurality of coil switches, the branch switch, the first inverter circuit, and the second inverter circuit,
wherein the controller is configured to close the branch switch and open one of the second coil switch and the third coil switch in response to a request to close the first coil switch or the fourth coil switch in a state in which the second coil switch and the third coil switch are closed and the branch switch is open.

6. The induction heating apparatus of claim 5, further comprising:
a vessel sensor configured to detect at least one cooking vessel placed on at least one of the plurality of cooking areas including a first cooking area, a second cooking area, a third cooking area and a fourth cooking area,
wherein the controller is configured to:
identify whether a second cooking vessel is additionally detected on the first cooking area corresponding to the first working coil or the fourth cooking area corresponding to the fourth working coil, in a state in which a first cooking vessel is detected on the second cooking area corresponding to the second working coil and the third cooking area corresponding to the third working coil, and
determine that the request to close the first coil switch or the fourth coil switch is made based on the second cooking vessel being detected.

7. The induction heating apparatus of claim 5, wherein the controller is configured to:
in response to the request to close the first coil switch or the fourth coil switch,
stop operating the first inverter circuit and the second inverter circuit, and
close the first coil switch or the fourth coil switch, close the branch switch, open one of the second coil switch and the third coil switch, and operate the first inverter circuit and the second inverter circuit again.

8. The induction heating apparatus of claim 7, further comprising:
an input interface configured to obtain a user input,
wherein the controller is configured to:
when operating the first inverter circuit again, determine a first output of the first inverter circuit based on the user input, and
when operating the second inverter circuit again, determine a second output of the second inverter circuit as a previous output of the second inverter circuit which is set before the operation of the second inverter circuit is stopped.

9. The induction heating apparatus of claim 5, further comprising:
an input interface configured to obtain a user input,
wherein the controller is configured to adjust a first output of the first inverter circuit and a second output of the second inverter circuit independently of each other based on the user input.

10. The induction heating apparatus of claim 1, wherein the first inverter circuit and the second inverter circuit are connected in parallel with each other.

11. A method of controlling an induction heating apparatus, the induction heating apparatus including a plurality of working coils corresponding to a plurality of cooking areas, a plurality of coil switches connected to the plurality of working coils, respectively, and a first inverter circuit and a second inverter circuit to apply an electric current to the plurality of working coils, wherein the plurality of working coils includes a first working coil connected to the first inverter circuit via a first coil switch, a second working coil connected to the first inverter circuit via a second coil switch, a third working coil connected to the second inverter circuit via a third coil switch, and a fourth working coil connected to the second inverter circuit via a fourth coil switch, the method comprising:
detecting, by a vessel sensor, a first cooking vessel on the second working coil and the third working coil when the first cooking vessel is placed on a second cooking area corresponding to the second working coil and a third cooking area corresponding to the third working coil, among the plurality of cooking areas;
closing, by a controller, the second coil switch and the third coil switch and opening a branch switch connected to the second working coil and the third working coil based on the first cooking vessel being detected;
detecting, by the vessel sensor, a second cooking vessel on the first working coil or the fourth working coil when the second cooking vessel is placed on a first cooking area corresponding to the first working coil or a fourth cooking area corresponding to the fourth working coil, among the plurality of cooking areas;
closing, by the controller, the first coil switch or the fourth coil switch based on the second cooking vessel being detected; and
closing the branch switch and opening one of the second coil switch and the third coil switch based on the second cooking vessel being detected.

12. The method of claim 11, wherein the first inverter circuit and the second inverter circuit are controlled to stop operating based on the second cooking vessel being detected on the first working coil or the fourth working coil; and
the first inverter circuit and the second inverter circuit are controlled to operate again after the plurality of coil switches and the branch switch are opened or closed.

13. The method of claim 12, wherein the operating of the first inverter circuit and the second inverter circuit again comprises:
determining a first output of the first inverter circuit based on a user input obtained through an input interface; and
determining a second output of the second inverter circuit as a previous output of the second inverter circuit which is set before the operation of the second inverter circuit is stopped.

14. The method of claim 11, wherein a first output of the first inverter circuit and a second output of the second inverter circuit are adjusted independently of each other based on a user input obtained through an input interface.

15. A method of controlling an induction heating apparatus, the induction heating apparatus including first o fourth working coils corresponding to first to fourth cooking areas, first to fourth coil switches connected to the first to fourth working coils, respectively, a first inverter circuit connected to the first working coil via the first coil switch and to the second working coil via the second coil switch, a second inverter circuit connected to the third working coil via the third coil switch and to the fourth working coil via the fourth coil switch, and a branch switch connected between a connection node of the second coil switch and the second working coil and a connection node of the third coil switch and the third working coil, the method comprising:
in response to a request of operating the second working coil and the third working coil, operating the first inverter circuit and the second inverter circuit, opening the first coil switch, closing the second coil switch, closing the third coil switch, opening the fourth coils switch, and opening the branch switch.

16. The method of claim 15, further comprising:
in response to a request of operating the first working coil in addition to the request of operating the second working coil and the third working coil, stopping the operating the first inverter circuit and the second inverter circuit, closing the first coil switch, opening the second coil switch, and closing the branch switch.

17. The method of claim 15, further comprising:
in response to a request of operating the fourth working coil in addition to the request of operating the second working coil and the third working coil, stopping the operating the first inverter circuit and the second inverter circuit, opening the third coil switch, closing the fourth coils switch, and closing the branch switch.
